(19) United States
(12) Patent Application Publication
(10) Pub. No.: US 2013/0317676 A1
(43) Pub. Date: Nov. 28, 2013

(54) SYSTEM AND METHOD FOR INSPECTING A ROUTE DURING MOVEMENT OF A VEHICLE SYSTEM OVER THE ROUTE

(71) Applicants: Jared Klineman Cooper, Melbourne, FL (US); Mark Bradshaw Kraeling, Melbourne, FL (US); Eugene A. Smith, Melbourne, FL (US); James Glen Corry, Melbourne, FL (US); David Lowell McKay, Melbourne, FL (US); Brian Joseph McManus, Fort Worth, TX (US); Keith Szewczyk, Melbourne, FL (US)

(72) Inventors: Jared Klineman Cooper, Melbourne, FL (US); Mark Bradshaw Kraeling, Melbourne, FL (US); Eugene A. Smith, Melbourne, FL (US); James Glen Corry, Melbourne, FL (US); David Lowell McKay, Melbourne, FL (US); Brian Joseph McManus, Fort Worth, TX (US); Keith Szewczyk, Melbourne, FL (US)

(21) Appl. No.: 13/478,388

(22) Filed: May 23, 2012

(51) Int. Cl. G06F 19/00; G06F 17/00

(52) U.S. Cl. 701/20; 701/19; 702/36

(57) ABSTRACT

A sensing system includes a leading sensor, a trailing sensor, and a route examining unit. The sensors are coupled to a vehicle system that travels along a route. The leading sensor acquires first inspection data indicative of a condition of the route as the vehicle system travels over the route. The condition may represent the health of the route. The trailing sensor acquires additional, second inspection data that is indicative of the condition to the route subsequent to the leading sensor acquiring the first inspection data. The route examining unit identifies a section of interest in the route based on the first inspection data acquired by the leading sensor. The route examining unit also directs the trailing sensor to acquire the second inspection data within the section of interest in the route when the first inspection data indicates damage to the route in the section of interest.

### FIELD

The inventive subject matter described herein relates to inspection systems

### BACKGROUND

Known inspection systems are used to examine routes traveled by vehicles for damage. For example, a variety of handheld, trackside, and vehicle mounted systems are used to examine railroad tracks for damage, such as cracks, pitting, or breaks. These systems are used to identify damage to the tracks prior to the damage becoming severe enough to cause accidents by vehicles on the tracks. Once the systems identify the damage, maintenance can be scheduled to repair or replace the damaged portion of the tracks.

Some known handheld inspection systems are carried by a human operator as the operator walks alongside the route. Such systems are relatively slow and are not useful for inspecting the route over relatively long distances. Some known trackside inspection systems use electronic currents transmitted through the rails of a track to inspect for broken rails. But, these systems are fixed in location and may be unable to inspect for a variety of other types of damage to the track other than broken rails.

Some known vehicle mounted inspection systems use sensors coupled to a vehicle that travels along the route. The sensors obtain ultrasound or optic data related to the route. The data is later inspected to determine damage to the route. But, some of these systems involve specially designed vehicles in order to obtain the data from the route. These vehicles are dedicated to inspecting the route and are not used for transferring large amounts of cargo or passengers long distances. Consequently, these types of vehicles add to the cost and maintenance of a fleet of vehicles without contributing to the capacity of the fleet to convey cargo or passengers.

Others of these types of vehicle mounted systems may be limited by using only a single type of sensor. Still others of these vehicle mounted inspection systems are limited in the types of sensors that can be used due to the relatively fast travel of the vehicles. For example, some sensors may require relatively slow traveling vehicles, which may be appropriate for specially designed vehicles but not for other vehicles, such as cargo or passenger trains having the sensors mounted thereto. The specially designed vehicles can be relatively expensive and add to the cost and maintenance of a fleet of vehicles.

### BRIEF DESCRIPTION

In one embodiment, a sensing system is provided that includes a leading sensor, a trailing sensor, and a route examining unit. As used herein, the term “leading” is meant to indicate that the sensor, vehicle, or other component travels over a location along the route ahead of (e.g., before) another sensor, vehicle, or other component (e.g., a “trailing” sensor, vehicle, or component) for a direction of travel. For example, in a first direction of travel, a first vehicle or sensor may be the leading vehicle or sensor when the first vehicle or sensor travels over a designated location before a second vehicle or sensor. The second vehicle or sensor may be the trailing vehicle. But, for an opposite, second direction of travel, the second vehicle or sensor may travel over the designated location before the first vehicle or sensor and, as a result, the second vehicle or sensor is the leading vehicle or sensor while the first vehicle or sensor is the trailing vehicle or sensor.

The leading sensor is configured to be coupled to a vehicle system that travels along a route. The leading sensor also is configured to acquire first inspection data indicative of a condition of the route as the vehicle system travels over the route. The condition may represent the health (e.g., damaged or not damaged, a degree of damage, and the like) of the route. The trailing sensor is configured to be coupled to the vehicle system and to acquire additional, second inspection data that is indicative of the condition to the route subsequent to the leading sensor acquiring the first inspection data. The route examining unit is configured to be disposed onboard the vehicle system and to identify a section of interest in the route based on the first inspection data acquired by the leading sensor. The route examining unit also is configured to direct the trailing sensor to acquire the second inspection data within the section of interest in the route when the first inspection data indicates damage to the route in the section of interest.

In another embodiment, a method (e.g., for acquiring inspection data of a route) includes acquiring first inspection data indicative of a condition of a route from a leading sensor coupled to a leading vehicle in a vehicle system as the vehicle system travels over the route, determining that the first inspection data indicates damage to the route in a section of interest in the route, and directing a trailing sensor coupled to a trailing vehicle of the vehicle system to acquire additional, second inspection data of the route when the first inspection data indicates the damage to the route. The leading vehicle and the trailing vehicle are mechanically directly or indirectly interconnected with each other in the vehicle system such that the leading vehicle passes over the section of interest of the route before the trailing vehicle.

In another embodiment, a sensing system includes a leading sensor, a trailing sensor, and a route examining unit. The leading sensor is configured to be coupled to a leading rail vehicle of a rail vehicle system that travels along a track. The leading sensor also is configured to acquire first inspection data indicative of a condition of the track in an examined section of the track as the rail vehicle system travels over the track. The trailing sensor is configured to be coupled to a trailing rail vehicle of the rail vehicle system and to acquire additional, second inspection data indicative of the condition to the track subsequent to the leading rail vehicle passing over the examined section of the track and the leading sensor acquiring the first inspection data. The route examining unit is configured to be disposed onboard the rail vehicle system. The route examining unit also is configured to direct the trailing sensor to acquire the second inspection data in the examined section of the track when the first inspection data indicates damage to the track such that both the leading sensor and the trailing sensor acquire the first inspection data and the second inspection data, respectively, of the examined section of the track during a single pass of the rail vehicle system over the examined section of the track.

In one aspect, a sensing system comprises a leading sensor configured to be coupled to a leading rail vehicle of a rail vehicle system that travels along a track. The leading sensor is also configured to automatically acquire first inspection data indicative of a condition of the track in an examined section of the track as the rail vehicle system travels over the track. The first inspection data is acquired at a first resolution level. The sensing system further comprises a trailing sensor configured to be coupled to a trailing rail vehicle of the rail vehicle system and to automatically acquire additional, second inspection data indicative of the condition of the track subsequent to the leading rail vehicle passing over the examined section of the track and the leading sensor acquiring the first inspection data. The second inspection data is acquired at a second resolution level that is greater than the first resolution level. The leading rail vehicle and the trailing rail vehicle are directly or indirectly mechanically connected in the rail vehicle system. The sensing system further includes a route examining unit configured to be disposed onboard the rail vehicle system. The route examining unit is also configured to automatically direct the trailing sensor to acquire the second inspection data in the examined section of the track when the first inspection data indicates damage to the track, such that both the leading sensor and the trailing sensor acquire the first inspection data and the second inspection data, respectively, of the examined section of the track during a single pass of the rail vehicle system over the examined section of the track. In one aspect, the rail vehicle system may be a train, and the leading rail vehicle and the trailing rail vehicle may be first and second locomotives of the train.

In another embodiment, a sensing system includes a route examining unit that is configured to be disposed onboard a vehicle system that travels along a route. The route examining unit also is configured to receive first inspection data from a leading sensor configured to be coupled to a leading vehicle of the vehicle system as the vehicle system travels over the route. The first inspection data is indicative of a condition of the route in an examined section of the route. The route examining unit is further configured to identify damage in the examined section of the route based on the first inspection data and to direct a trailing sensor to acquire second inspection data in the examined section of the route responsive to identifying the damage. The trailing sensor is configured to be coupled to a trailing vehicle of the vehicle system that is indirectly or directly mechanically coupled to the leading vehicle.

### BRIEF DESCRIPTION OF THE DRAWINGS

Reference is now made briefly to the accompanying drawings, in which:

FIG. 1 is a schematic diagram of a vehicle system traveling along a route in accordance with one embodiment of the inventive subject matter;

FIG. 2 illustrates one example of the vehicle system shown in FIG. 1 approaching a damaged portion of the route shown in FIG. 1;

FIG. 3 illustrates one example of a leading sensor shown in FIG. 1 of a sensing system shown in FIG. 2 passing over the damaged portion of the route as shown in FIG. 2;

FIG. 4 illustrates a trailing sensor of the sensing system shown in FIG. 2 subsequently passing over the damaged portion of the route as shown in FIG. 2;

FIG. 5 is a schematic diagram of one embodiment of the sensing system shown in FIG. 2;

FIG. 6 is a schematic diagram of one embodiment of the vehicle shown in FIG. 1; and

FIG. 7 is a flowchart of one embodiment of a method for obtaining inspection data of a potentially damaged route.

### DETAILED DESCRIPTION

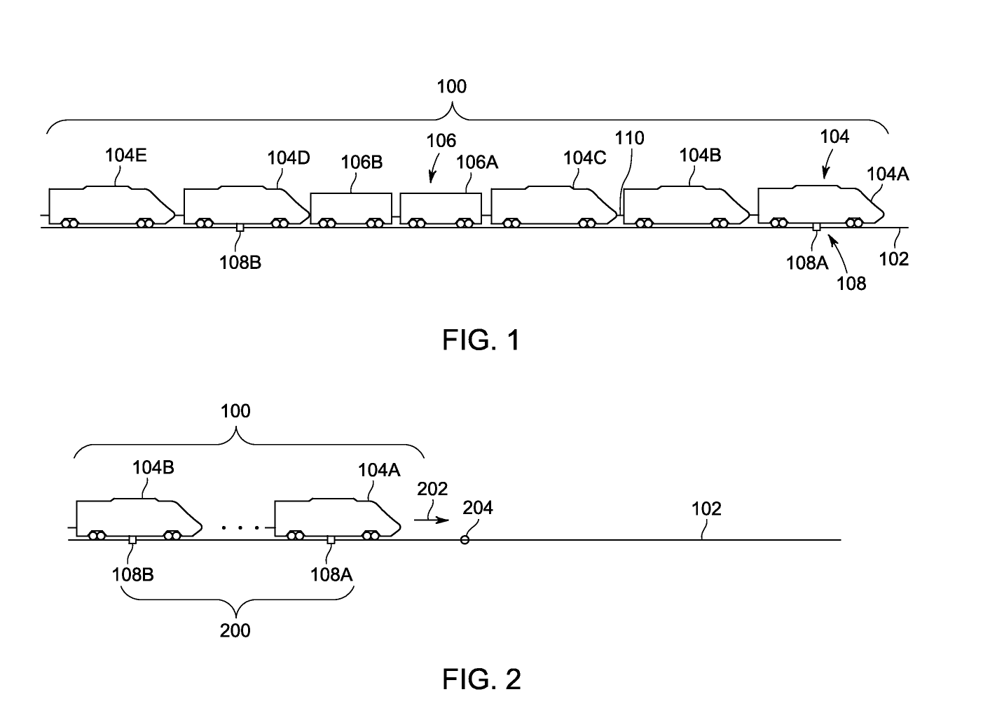

FIG. 1 is a schematic diagram of a vehicle system 100 traveling along a route 102 in accordance with one embodiment of the inventive subject matter. The vehicle system 100 includes several powered vehicles 104 (e.g., powered vehicles 104A-E) and several non-powered vehicles 106 (e.g., non-powered vehicles 106A-B) mechanically interconnected with each other such that the vehicles 104, 106 travel together as a unit. The vehicles 104, 106 may be connected with each other by coupler devices 110. The terms “powered” and “non-powered” indicate the capability of the different vehicles 104, 106 to self-propel. For example, the powered vehicles 104 represent vehicles that are capable of self-propulsion (e.g., that include motors that generate tractive effort). The non-powered vehicles 106 represent vehicles that are incapable of self-propulsion (e.g., do not include motors that generate tractive effort), but may otherwise receive or use electric current for one or more purposes other than propulsion. In the illustrated embodiment, the powered vehicles 104 are locomotives and the non-powered vehicles 106 are non-locomotive rail cars linked together in a train. (Examples of non-powered rail vehicles include box cars, tanker cars, flatbed cars, and other cargo cars, and certain types of passenger cars.) Alternatively, the vehicle system 100, powered vehicles 104, and/or non-powered vehicles 106 may represent another type of rail vehicle, another type of off-highway vehicle, automobiles, and the like. The route 102 may represent a track, road, and the like.

In one embodiment, the vehicle system 100 operates in a distributed power (DP) arrangement, where at least one powered unit 104 is designated as a lead unit that controls or dictates operational settings (e.g., brake settings and/or throttle settings) of other powered units (e.g., trailing powered units 104) in the vehicle system 100. The powered units 104 may communicate with each other to coordinate the operational settings according to the commands of the leading powered unit 104 through one or more communication links, such as a wireless radio communication link, an electronically controlled pneumatic (ECP) brake line, and the like.

The vehicle system 100 includes plural sensors 108 (e.g., sensors 108A, 108B) that monitor the route 102 for damage as the vehicle system 100 moves along the route 102. While only two sensors 108 are shown in the illustrated embodiment, the vehicle system 100 may include additional sensors 108. Additionally, while the sensors 108 are shown coupled with the powered vehicles 104, one or more of the sensors 108 may be coupled with a non-powered vehicle 106. The sensors 108 can examine the route 102 for damage such as broken sections of a rail, pitted sections of a road or rail, cracks on an exterior surface or interior of a rail or road, and the like. The sensors 108 may be the same or different types of sensors that examine the route 102. By “types,” it is meant that the sensors 108 may use different technologies or techniques to examine the route 102, such as ultrasound, electric current, magnetic fields, optics, acoustics, distance measurement, force displacement, and the like, representing some different technologies or techniques.

For example, with respect to ultrasound, one or more of the sensors 108 may include an ultrasound transducer that emits ultrasound pulses into the route 102 and monitors echoes of the pulses to identify potential damage to the route 102. With respect to electric current, one or more of the sensors 108 may include probes that measure the transmission of electric current through the route 102, such as by using a section of the route 102 to close a circuit, to identify damage to the route 102. An opening of the circuit can be indicative of a broken portion of the route 102, such as a broken rail. With respect to magnetic fields, one or more the sensors 108 may measure eddy currents in the route 102 when the route 102 is exposed to a magnetic field. With respect to optics, the sensors 108 may acquire video and/or static images of the route 102 to identify damage to the route 102. Alternatively or additionally, the sensors 108 may use optics, such as laser light, to measure a profile, positions, or displacement of the route 102 (e.g., displacement of rails of a track). With respect to acoustics, the sensors 108 may monitor sounds, such as sounds created when the vehicle system 100 travels over the route 102, to identify damage to the route 102. With respect to distance measurement, the sensors 108 may include probes that engage the route 102 to measure distances to or between portions of the route 102 to identify damage. With respect to force displacement, the sensors 108 may include probes that engage and attempt to push sections of the route 102 to identify damage and/or strength of the route 102.

The sensors 108 that are in the vehicle system 100 may be the same or different types of sensors 108. Additionally or alternatively, one or more of the sensors 108 may represent a sensor array that includes two or more of the same or different types of sensors 108. The sensors 108 acquire data (e.g., ultrasound data, electric circuit data, eddy current data, magnetic data, optic data, displacement data, force data, acoustic data, and the like) that represents a condition of the route 102. This data is referred to as inspection data.

One of the sensors 108A is positioned ahead of another one of the sensors 108B along a direction of travel of the vehicle system 100. The sensor 108A that is positioned ahead of the sensor 108B is referred to as a leading sensor while the sensor 108B that is positioned behind or downstream from the leading sensor 108A along the direction of travel of the vehicle system 100 is referred to as a trailing sensor 108B. The vehicle 104, 106 to which the leading sensor 108A is coupled can be referred to as the leading vehicle (e.g., the leading powered vehicle 104A) and the vehicle 104, 106 to which the trailing sensor 108B is coupled is referred to as the trailing vehicle (e.g., the trailing powered vehicle 104D).

As the vehicle system 100 moves along the route 102, the sensors 108 acquire inspection data of the route 102 to monitor the condition of the route 102. The sensors 108 obtain inspection data that is examined (e.g., by a route examination unit) to identify potential sections of interest in the route 102 that may include damage to the route 102, such as breaks in a rail, cracks in the route 102, pitting in the route 102, and the like.

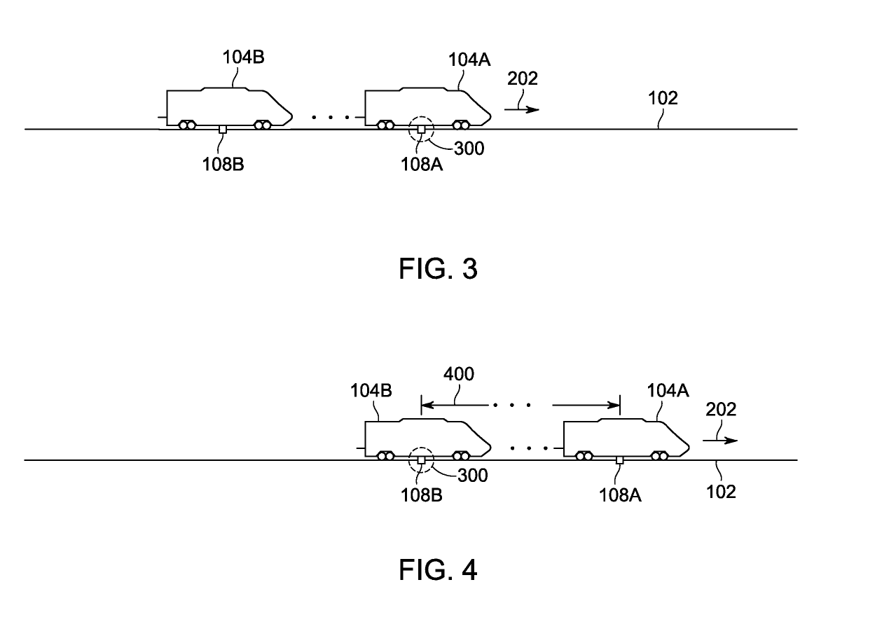

FIGS. 2 through 4 illustrate one example of operation of a sensing system 200 of the vehicle system 100. The sensing system 200 includes the sensors 108 of the vehicle system 100. Only the leading and trailing vehicles 104A, 104B of the vehicle system 100 are shown in FIG. 1, but, as described above, one or more powered and/or non-powered vehicles 104, 106 may be disposed between and interconnected with the leading and trailing vehicles 104A, 104B. FIG. 2 shows the vehicle system 100 approaching a damaged portion 204 of the route 102, FIG. 3 shows the leading sensor 108A of the sensing system 200 passing over the damaged portion 204 of the route 102, and FIG. 4 shows the trailing sensor 108B of the sensing system 200 subsequently passing over the damaged portion 204 of the route 102. The damaged portions 204 of the route 102, such as sections of the route 102 that include cracks, breaks, pitting, and the like.

In operation, the vehicle system 100 moves along the route 102 in a direction of travel 202. The leading sensor 108A may acquire inspection data of the route 102 as the vehicle system 100 moves along the route 102. The leading sensor 108A can acquire the inspection data on a periodic or continual basis, when automatically prompted by a control unit (described below) of the vehicle system 100, and/or when manually prompted by an operator of the vehicle system 100 using an input device (described below).

When the leading sensor 108A passes over the damaged portion 204 of the route 102 (as shown in FIG. 3), the leading sensor 108A may acquire inspection data representative of the damage to the route 102 in the damaged portion 204. This inspection data can be examined by the route examining unit (described below) of the vehicle system 100 to identify potential damage to the route 102. The sensing system 200 can designate the section of the route 102 that includes the identified potential damage as a section of interest 300 in the route 102. The section of interest 300 may be identified as including portions of the route 102 in addition to the location where the potential damage is identified. For example, the sensing system 200 can designate the section of interest 300 as including an additional margin (e.g., section) of the route 102 ahead of and/or behind (e.g., along the direction of travel 202) the location where the potential damage is identified. Designating the section of interest 300 as including more of the route 102 than just the exact location of where the potential damage is identified can increase the probability that the trailing sensor 108B can acquire inspection data of the entire damage to the route 102 in or near the damaged portion 204.

Alternatively, the section of interest 300 may represent an examined section of the route 102, or a section of the route 102 that is being examined for damage relative to other sections of the route 102. For example, the leading sensor 108A may be activated to acquire inspection data only for designated or selected (e.g., autonomously or manually selected) portions of the route 102. The section of interest 300 may represent at least one of the designated or selected portions that are associated with potential damage to the route 102, as determined from the inspection data acquired by the leading sensor 108A.

In response to identifying the section of interest 300, the sensing system 200 may direct the trailing sensor 108B to acquire additional inspection data of the route 102 in the section of interest 300. In one embodiment, the trailing sensor 108B is inactive (e.g., such as by being deactivated, turned OFF, or otherwise not obtaining inspection data of the route 102) until activated by the sensing system 200 in response to the section of interest 300 being identified from inspection data acquired by the leading sensor 108A. The sensing system 200 can determine when the trailing sensor 108B will pass over the section of interest 300 (as shown in FIG. 4) based on one or more characteristics of the vehicle system 100.

For example, the sensing system 200 can determine when the trailing sensor 108B will pass over the section of interest 300 based on the velocity of the vehicle system 100 along the direction of travel 202 and a separation distance 400 between the leading and trailing sensors 108A, 108B along the vehicle system 100. In an embodiment where the vehicle system 100 includes several vehicles 104, 106 following a curved route 102 and/or undulating route 102 (e.g., that passes over one or more hills, mounds, dips, and the like), the separation distance 400 can be measured along the length of the vehicle system 100 as the vehicle system 100 curves and/or undulates along the route 102. The sensing system 200 can determine when the trailing sensor 108B will pass over the section of interest 300 based on the separation distance 400 and the velocity of the vehicle system 100 and then direct the trailing sensor 108B to acquire the additional inspection data of the section of interest 300 when (or just prior to) the trailing sensor 108B passing over the section of interest 300.

Alternatively, the trailing sensor 108B may be actively acquiring additional inspection data of the route 102 when the sensing system 200 identifies the section of interest 300 based on the inspection data from the leading sensor 108A. The sensing system 200 may then flag or otherwise designate the inspection data acquired by the trailing sensor 108B when the trailing sensor 108B passes over the section of interest 300 as being inspection data of interest (e.g., data obtained from the section of interest 300).

In response to identifying the section of interest 300, the sensing system 200 may direct the trailing sensor 108B to acquire the additional inspection data at a greater (e.g., finer) resolution or resolution level relative to the inspection data acquired by the leading sensor 108A. For example, the trailing sensor 108B may be directed to acquire more measurements of the route 102 per unit time than the leading sensor 108A. Alternatively or additionally, the trailing sensor 108B may be directed to acquire measurements having greater detail (e.g., data) of the potential damage to the route 102 than the leading sensor 108A. Alternatively or additionally, the trailing sensor 108B may be directed to acquire a different type of inspection data of the route 102 than the leading sensor 108A. Alternatively or additionally, the trailing sensor 108B may be directed to acquire more measurements (e.g., more inspection data) of the potential damage to the route 102 than the leading sensor 108A.

The sensing system 200 may be in communication with a propulsion system (described below) of the vehicle system 100 to coordinate movement of the vehicle system 100 with the locations of the leading sensor 108A and/or trailing sensor 108B in response to identification of the section of interest 300 in the route 102.

For example, when the section of interest 300 is identified based on the inspection data from the leading sensor 108A, the sensing system 200 may communicate with a controller (described below) of the vehicle system 100 that autonomously controls the propulsion system of the vehicle system 100 so that the velocity of the vehicle system 100 slows down when the trailing sensor 108B passes over the section of interest 300. Alternatively or additionally, the controller may generate commands that are output to an operator of the vehicle system 100 to direct the operator to manually control propulsion system of the vehicle system 100 so that the velocity of the vehicle system 100 slows down when the trailing sensor 108B passes over the section of interest 300. The vehicle system 100 can slow down just prior to the trailing sensor 108B passing over the section of interest 300, as soon as the section of interest 300 is identified, and/or when the trailing sensor 108B reaches the section of interest 300. The vehicle system 100 may slow down so that the trailing sensor 108B can acquire the additional inspection data at a higher resolution than the inspection data from the leading sensor 108A. For example, if both the leading and trailing sensors 108A, 108B acquire inspection data at the same or approximately the same rate, then slowing down the vehicle system 100 when the trailing sensor 108B acquires the inspection data can allow for more inspection data (e.g., data at a higher resolution) from the trailing sensor 108B than the inspection data from the leading sensor 108A. Even if the leading and trailing sensors 108A, 108B acquire inspection data at different rates, slowing down the vehicle system 100 can allow for the trailing sensor 108B to acquire the inspection data at a greater resolution

As another example, when the section of interest 300 is identified based on the inspection data from the leading sensor 108A, the sensing system 200 may communicate with the propulsion system of the vehicle system 100 in order to change a slack in one or more coupler devices 110 between the connected vehicles 104, 106. For example, the propulsion system may change movement of the vehicle system 100 so that forces exerted on one or more of the coupler devices 110 are modified. The slack may be modified by reducing the slack (e.g., increasing the tensile forces on the coupler device 110) between the trailing vehicle 104B and one or more of the vehicles 104, 106 coupled with the trailing vehicle 104B. Reducing the slack can allow for reduced movement of the trailing vehicle 104B and the trailing sensor 108B relative to the other vehicles 104, 106 in the vehicle system 100. Such reduced movement also can reduce noise in the inspection data and/or erroneous inspection data acquired by the trailing sensor 108B.

The operation of the vehicle system 100 described above allows for the sensing system 200 to acquire inspection data of one or more sections of interest 300 in the route 102 by two or more sensors 108A, 108B at two or more different locations in the vehicle system 100 during a single pass of the vehicle system 100 over the section of interest 300. The multiple inspections may be performed to acquire different types of inspection data, different amounts of inspection data, inspection data at different resolutions, and the like, during a single pass of the vehicle system 100 over the section of interest 300.

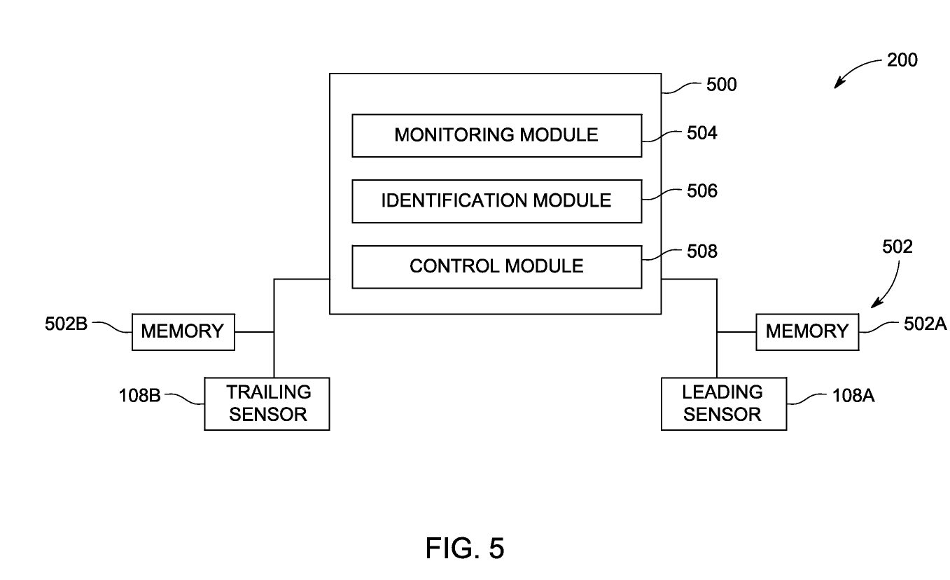

FIG. 5 is a schematic diagram of one embodiment of the sensing system 200. The sensing system 200 may be distributed among multiple vehicles 104, 106 (shown in FIG. 1) of the vehicle system 100 (shown in FIG. 1). For example, a route examining unit 500 of the sensing system 200 may be disposed on the same or different vehicle 104, 106 as the leading sensor 108A and/or the trailing sensor 108B. As used herein, the terms “unit” or “module” (such as the route examining unit 500, communication unit, and the like) include a hardware and/or software system that operates to perform one or more functions. For example, a unit or module may include one or more computer processors, controllers, and/or other logic-based devices that perform operations based on instructions stored on a tangible and non-transitory computer readable storage medium, such as a computer memory. Alternatively, a unit or module may include a hard-wired device that performs operations based on hard-wired logic of a processor, controller, or other device. In one or more embodiments, a unit or module includes or is associated with a tangible and non-transitory (e.g., not an electric signal) computer readable medium, such as a computer memory. The units or modules shown in the attached figures may represent the hardware that operates based on software or hardwired instructions, the computer readable medium used to store and/or provide the instructions, the software that directs hardware to perform the operations, or a combination thereof.

The route examining unit 500 is communicatively coupled (e.g., by one or more wired and/or wireless communication links 502) with the leading sensor 108A and the trailing sensor 108B. The communication links 502 can represent wireless radio communications between powered units 104 in a DP arrangement or configuration, as described above, communications over an ECP line, and the like. The route examining unit 500 is communicatively coupled with the sensors 108A, 108B to receive inspection data from the sensors 108A, 108B and to direct operations of the sensors 108A, 108B. For example, in response to receiving and examining the inspection data from the leading sensor 108A, the route examining unit 500 may direct the trailing sensor 108B to acquire additional inspection data, as described above. In one embodiment, the inspection data obtained by one or more of the sensors 108A, 108B may be stored in a tangible and non-transitory computer readable storage medium, such as a computer memory 502 (e.g., memories 502A, 502B). The memories 502A, 502B may be localized memories that are disposed at or near (e.g., on the same vehicle 104, 106) as the sensors 108A, 108B that store the inspection data on the respective memory 502A, 502B.

The route examining unit 500 includes several modules that perform one or more functions of the route examining unit 500 described herein. The modules include a monitoring module 504 that monitors operations of the sensors 108A, 108B. The monitoring module 504 may track which sensors 108A, 108B are acquiring inspection data (e.g., which sensors 108 are active at one or more points in time) and/or monitor the health or condition of the sensors 108 (e.g., whether any sensors 108 are malfunctioning, such as by providing inspection data having noise above a designated threshold or a signal-to-noise ratio below a designated threshold). The monitoring module 504 may monitor operations of the vehicle system 100, such as the velocity of the vehicle system 100 and/or forces exerted on one or more coupler devices 110 (shown in FIG. 1) in the vehicle system 100.

An identification module 506 examines the inspection data provided by the sensors 108. The identification module 506 may receive the inspection data from the leading sensor 108A and determine if the inspection data is indicative or representative of potential damage to the route 102. For example, with respect to ultrasound data that is acquired as the inspection data, the identification module 506 may examine the ultrasound echoes off the route 102 to determine if the echoes represent potential damage to the route 102. Additionally or alternatively, the identification module 506 may form images from the ultrasound echoes and communicate the images to an output device (described below) so that an operator of the vehicle system 100 can manually examine the images. The operator may then manually identify the potential damage and/or confirm identification of the potential damage by the identification module 506.

The identification module 506 may examine changes in electric current transmitted through the route 102, such as by identifying openings or breaks in a circuit that is otherwise closed by the route 102. The openings or breaks can represent a broken or damaged portion of the route 102. The identification module 506 can examine the eddy currents in the route 102 when the route 102 is exposed to a magnetic field in order to determine magnetoresistive responses of the route 102 (e.g., a rail). Based on these responses, the identification module 506 can identify potential cracks, breaks, and the like, in the route 102.

The identification module 506 can examine videos or images of the route 102 to identify damage to the route 102. Alternatively or additionally, the identification module 506 may examine a profile, positions, or displacement of the route 102 to identify potential damage. The identification module 506 may form images from the videos, images, profiles, positions, or displacement and communicate the images to an output device (described below) so that an operator of the vehicle system 100 can manually examine the images. The operator may then manually identify the potential damage and/or confirm identification of the potential damage by the identification module 506

The identification module 506 can examine the sounds (e.g., frequency, duration, and the like) measured by the sensors 108 to identify potential damage to the route 102. The identification module 506 can examine distances to or between portions of the route 102 and compare these distances to known or designated distances to identify potential damage to the route 102. The identification module 506 may examine force measurements from probes of the sensors 108 that engage and attempt to push sections of the route 102 to identify potential damage and/or mechanical strength of the route 102 (which can be indicative of potential damage to the route 102).

The identification module 506 identifies the location of the potential damage, such as by identifying where the section of interest 300 (shown in FIG. 3) is located along the route 102. The identification module 506 may communicate with a location determination system (described below) of the vehicle system 100 to determine where the section of interest 300 is located. For example, upon identifying the potential damage, the identification module 506 can obtain the current location of the vehicle system 100 (or a previous location of the vehicle system 100 that corresponds to when the inspection data indicative of the potential damage was acquired) and designate the location as the location of the section of interest 300.

The route examining unit 500 includes a control module 508 that controls operations of the sensing system 200. The control module 508 can transmit signals to the sensors 108 to direct the sensors 108 to activate and/or begin collecting inspection data of the route 102. The control module 508 may instruct the sensors 108 as to how much inspection data is to be obtained, the resolution of the inspection data to be obtained, when to begin collecting the inspection data, how long to collect the inspection data, and the like. The control module 508 can communicate with the identification module 506 to determine when potential damage to the route 102 is identified.

In one embodiment, the control module 508 automatically directs the sensors 108 to acquire inspection data. For example, responsive to the leading sensor 108A acquiring inspection data that is indicative of potential damage to the route 102, the control module 508 may autonomously (e.g., without operator intervention or action) direct the trailing sensor 108B to begin acquiring the additional inspection data, as described herein.

The control module 508 may select the resolution level at which the trailing sensor 108B is to acquire the additional inspection data from among several available resolution levels (e.g., resolution levels that the trailing sensor 108B is capable of acquiring). For example, the trailing sensor 108B may be associated with several different resolution levels that acquire the inspection data at different resolutions. When the control module 508 determines that the inspection data acquired by the leading sensor 108A indicates potential damage to the route 102, the control module 508 can select at least one of the resolution levels of the trailing sensor 108B and direct the trailing sensor 108B to acquire the additional inspection level at the selected resolution level.

In one embodiment, the control module 508 can autonomously select the resolution level (e.g., without operator input or intervention). For example, the control module 508 can select the resolution level for the trailing sensor 108B based on a current speed of the vehicle system 100, a category of the potential damage to the route 102, and/or a degree of the potential damage to the route 102. Different resolution levels can be associated with different speeds, categories of damage, and/or degrees of damage. For example, faster speeds may be associated with greater resolution levels while slower speeds are associated with lower resolution levels. As another example, a category of damage that includes damage to the interior of the route 102 (e.g., inside a rail) may be associated with greater resolution levels than a category of damage that includes damage to the exterior of the route 102. In another example, greater degrees of damage (e.g., more damage, such as a larger volume of damage, larger pits, larger cracks, larger voids, and the like) may be associated with a different resolution level than lesser degrees of damage. Once the speed, category of damage, and/or degree of damage is determined by the control module 508 (e.g., such as from a speed sensor described below and/or the identification module 506 that identifies the category and/or degree of damage), the control module 508 determines the associated resolution level, such as from information stored in an internal or external memory. The control module 508 may then automatically direct the trailing sensor 108B to acquire the additional inspection data at the selected resolution level.

Alternatively, upon identification of potential damage to the route 102 from the inspection data acquired by the leading sensor 108A, the control module 508 may direct an output device (e.g., the device 608 described below) to present the operator of the vehicle system 100 with one or more choices of resolution levels. The resolution levels that are presented to the operator may be associated with the speed of the vehicle system 100, category of damage, and/or degree of damage, as described above. The operator may then use an input device (e.g., the input device 606 described below) to select the resolution level that is to be used by the trailing sensor 108B to acquire the additional inspection data of the route 102.

The control module 508 can communicate with a control unit (described below) of the vehicle system 100 to control or modify movement of the vehicle system 100 in response to identification of potential damage to the route 102. For example, in response to the identification module 506 determining that the inspection data from the leading sensor 108A is indicative of potential damage to the route 102, the control module 508 can instruct the control unit to slow down movement of the vehicle system 100 prior to the trailing sensor 108B passing over the section of interest 300 and/or to alter movement of the vehicle system 100 in order to change the slack in the vehicle system 100, as described above.

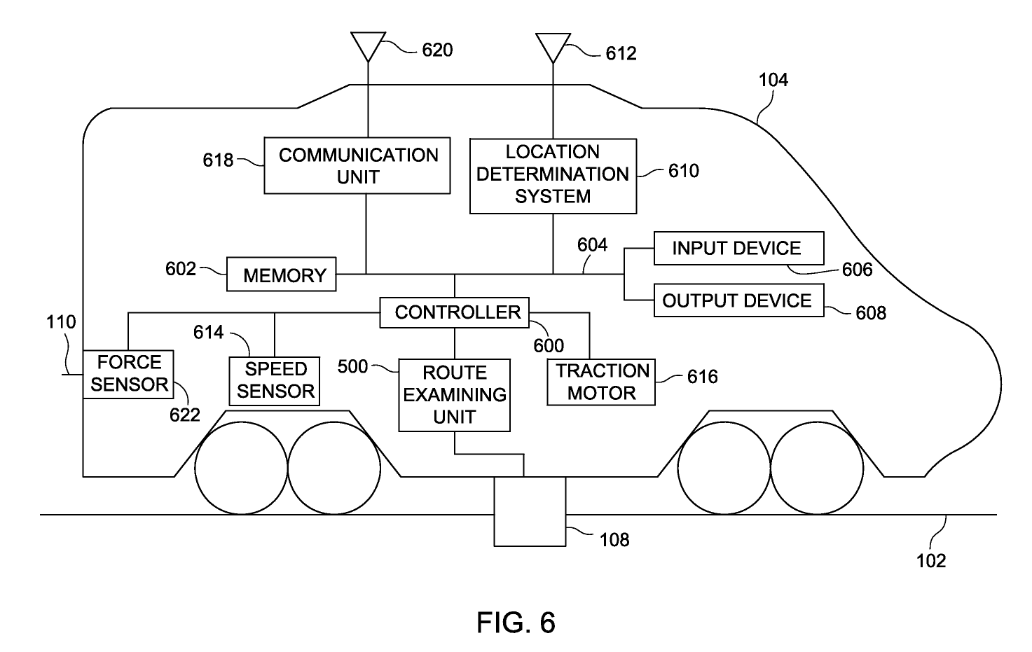

FIG. 6 is a schematic diagram of one embodiment of the powered vehicle 104. The vehicle 104 may represent the leading vehicle 104A, the trailing vehicle 104B, or another vehicle 104 shown in FIG. 1. The vehicle 104 includes a controller 600 that controls operations of the vehicle 104. The controller 600 may be embodied in hardware and/or software systems that operate to control operations of the vehicle 104 and/or vehicle system 100. The controller 600 may include one or more computer processors, controllers, and/or other logic-based devices that perform operations based on instructions stored on a tangible and non-transitory computer readable storage medium, such as a computer memory 602. Alternatively or additionally, the controller 600 may include a hard-wired device that performs operations based on hard-wired logic of a processor, controller, or other device.

The controller 600 is communicatively coupled (e.g., with one or more wired and/or wireless communication links 604) with various components used in operation of the vehicle 104 and/or vehicle system 100. The controller 600 is communicatively coupled with an input device 606 (e.g., levers, switches, touch screen, keypad, and the like) to receive manual input from an operator of the vehicle 104 or vehicle system 100 and an output device 608 (e.g., display device, speakers, lights, haptic device, and the like) to present information to the operator of the vehicle 104 or vehicle system 100. The input device 606 may be used by the operator to manually control when one or more of the sensors 108 of the sensing system 200 (shown in FIG. 2) collect inspection data of the route 102, the resolution of the inspection data that is collected, the amount of inspection data that is collected, the type of inspection data that is acquired, and the like. The input device 606 may be used by the operator to manually confirm identification of potential damage to the route 102 based on the inspection data. The output device 608 can present information concerning the potential damage to the route 102 to the operator, such as the location of the section of interest 300, information representative of the inspection data (e.g., video, images, numbers, values, and the like, of the inspection data).

A location determination system 610 is communicatively coupled with the controller 600. The location determination system 610 obtains data representative of actual locations of the vehicle system 100 and/or the vehicle 104. The location determination system 610 may wirelessly receive signals using transceiver and associated circuitry (shown as an antenna 612 in FIG. 6), such as signals transmitted by Global Positioning System satellites, signals transmitted by cellular networks, and the like. The location determination system 610 may use these signals to determine the location of the vehicle system 100 and/or vehicle 104, and/or convey the signals to the controller 600 for determining the location of the vehicle system 100 and/or vehicle 104. In another embodiment, the location determination system 610 may receive speed data indicative of the velocity of the vehicle system 100 from a speed sensor 614 of the vehicle 104 (or another vehicle 104, 106 in the vehicle system 100). The location determination system 610 may determine the velocity of the vehicle system 100 based on the speed data and can use an amount of time elapsed since passing or leaving a designated location in order to determine the current location of the vehicle system 100 or vehicle 104. As described above, the route examining unit 500 (shown in FIG. 5) of the sensing system 200 may communicate with the location determination system 610 to obtain the location of the vehicle 104 when the sensor 108 identifies potential damage to the route 102 in one embodiment.

The controller 600 is communicatively coupled with a propulsion system that includes one or more traction motors (shown as “Traction Motor 616”) in FIG. 6) for providing tractive effort to propel the vehicle 104. Although not shown in FIG. 6, the propulsion system may be powered from an on-board power source (e.g., engine and alternator, battery, and the like) and/or an off-board power source (e.g., electrified rail, catenary, and the like). The controller 600 can communicate control signals to the propulsion system to control the speed, acceleration, and the like, of the vehicle 104. The control signals may be based off of manual input received from the input device 606 and/or may be autonomously generated.

For example, when the route examining unit 500 identifies potential damage to the route 102, the route examining unit 500 may direct the controller 600 to change movement of the vehicle system 100. The route examining unit 500 may direct the controller 600 to slow down movement of the vehicle system 100 in response to identification of the potential damage to the route 102 by the leading sensor 108A. The controller 600 may then autonomously control the propulsion system of the vehicle 104 to slow down movement of the vehicle 104. With respect to other vehicles 104, 106 in the vehicle system 100, the controller 600 may transmit control signals to other vehicles 104 that direct the vehicles 104 also to autonomously slow down movement. A communication unit 618 (e.g., transceiver circuitry and hardware, such as a wireless antenna 620) may be communicatively coupled with the controller 600 to communicate these control signals to the other vehicles 104 in the vehicle system 100 so that the other vehicles 104 slow down movement of the vehicle system 100. Additionally or alternatively, the communication unit 618 may communicate with the other vehicles 104, 106 via one or more wired connections extending through the vehicle system 100. In another embodiment, the controller 600 may generate and communicate command signals to the output device 608 that cause the output device 608 to present information to the operator of the vehicle system 100 to manually control the vehicle system 100 to slow down the vehicle system 100.

A force sensor 622 is connected with the coupler device 110 for measuring force data of the coupler device 110. The force data may represent or be indicative of the amount of slack between the illustrated vehicle 104 and another vehicle 104 or 106 coupled with the illustrated vehicle 104 by the coupler device 110. For example, the force data may represent tensile or compressive forces exerted by the coupler device 110. Additionally or alternatively, the force data can include distance measurements to the other vehicle 104, 106 that is coupled with the illustrated vehicle 104, which may represent or be indicative of the slack in the coupler device 110. Additional force sensors 602 may be disposed onboard other vehicles 104, 106 in the vehicle system 100 to measure the force data of the coupler devices 110 joining the other vehicles 104, 106. The force data may be communicated to the illustrated vehicle 104 via the communication unit 618.

The force data can be communicated to the route examining unit 500 to be monitored, as described above. If the route examining unit 500 determines that the slack between vehicles 104, 106 is to be changed (e.g., increased or reduced) in response to identification of potential damage to the route 102 by the leading sensor 108A, then the route examining unit 500 can direct the controller 600 to change movement of the vehicle system 100 to effectuate the change in slack. The controller 600 can transmit signals to the propulsion system of the illustrated vehicle 104 and to other vehicles 104, 106 in the vehicle system 100 to autonomously apply braking and/or tractive effort to alter the slack between the vehicles 104, 106 as requested by the route examining unit 500. Alternatively, the controller 600 may generate and communicate command signals to the output device 608 that cause the output device 608 to present information to the operator of the vehicle system 100 to manually control the vehicle system 100 to change the slack in the vehicle system 100, such as by stretching out the coupler devices 110 to reduce slack in the vehicle system 100.

In one embodiment, the route examining unit 500 may communicate with an off-board location, such as a dispatch center, a repair or maintenance facility, and the like, when potential damage to the route 102 is identified. For example, in response to the route examining unit 500 identifying potential damage to the route 102 based on the inspection data obtained by the leading sensor 108A and/or the damage being confirmed by examination of the additional inspection data obtained by the trailing sensor 108B, the route examining unit 500 may transmit a signal to the off-board location to request repair to the damaged portion 204 of the route 102. This signal may communicate the location of the section of interest 300, the location of the actually damaged portion 204, the time at which the damage was identified, and/or an identification of the type or category of damage (e.g., external cracks, internal cracks, external pitting, internal voids, displacement of tracks, and the like) to the off-board location via the communication unit 618. The type or category of damage can represent a classification of the damage. For example, one category of damage may be external damage to the route 102 (e.g., damage that is on an exterior surface and/or extends to the exterior surface), while another category includes interior damage (e.g., damage that is inside the route 102 and not on the exterior surface). As another example, other categories of damage may be defined by the evidence of the damage, such as categories of cracks, pits, voids, and the like. Alternatively, other categories may be used. The off-board location can then send a repair crew to fix and/or replace the damaged portion 204 of the route 102.

In another embodiment, the route examining unit 500 may communicate with another vehicle or vehicle system (that is not coupled with the vehicle system 100) to warn the other vehicle or vehicle system of the damaged portion 204 of the route 102. For example, in response to the route examining unit 500 identifying potential damage to the route 102 based on the inspection data obtained by the leading sensor 108A and/or the damage being confirmed by examination of the additional inspection data obtained by the trailing sensor 108B, the route examining unit 500 may transmit a signal to one or more other vehicles or vehicle systems traveling on the route 102 to warn the other vehicles or vehicle systems of the damaged portion 204 of the route 102. The signal may be transmitted to designated vehicles or vehicle systems (e.g., addressed to specific vehicles or vehicle systems as opposed to broadcast to any or several vehicles or vehicle systems within range) using the communication unit 618. Alternatively, the signal may be broadcast for reception by any vehicles or vehicle systems within range of communication, as opposed to being addressed and sent to specific vehicles or vehicle systems. This signal may communicate the location of the section of interest 300, the location of the actually damaged portion 204, the time at which the damage was identified, and/or an identification of the type of damage (e.g., external cracks, internal cracks, external pitting, internal voids, displacement of tracks, and the like) to the off-board location via the communication unit 618. The vehicles or vehicle systems that receive the signal may then adjust travel accordingly. For example, the vehicles or vehicle systems may change course to avoid traveling over the damaged portion 204, may slow down when traveling over the damaged portion 204, and the like.

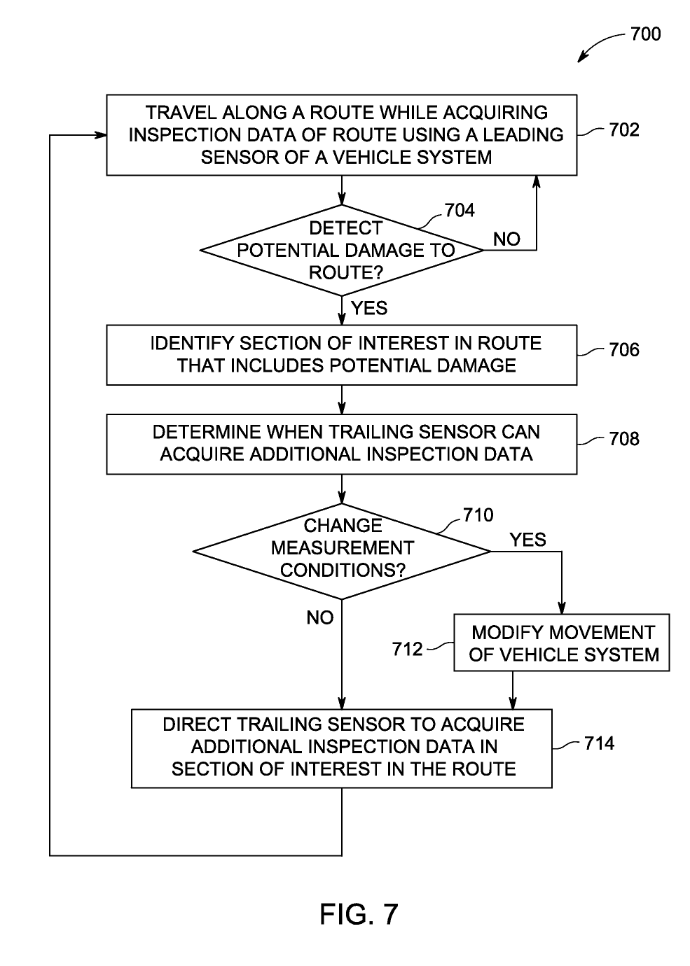

FIG. 7 is a flowchart of one embodiment of a method 700 for obtaining inspection data of a potentially damaged route. The method 700 may be used in conjunction with one or more embodiments of the sensing system 200 (shown in FIG. 2). For example, the method 700 may be used to acquire inspection data of the route 102 (shown in FIG. 1) from plural sensors 108 (shown in FIG. 1) or arrays of sensors 108 in the vehicle system 100 during a single pass of the vehicle system 100 over the route 102.

At 702, the vehicle system 100 travels along the route 102 while acquiring inspection data of the route 102 using the leading sensor 108A of the vehicle system 100. As described above, the leading sensor 108A may acquire the inspection data periodically, continuously, and/or when manually or autonomously prompted to collect the data.

At 704, a determination is made as to whether the inspection data obtained by the leading sensor 108A is indicative of potential damage to the route 102. As described above, the route examining unit 500 (shown in FIG. 5) can determine if the inspection data from the leading sensor 108A represents damage to the route 102. If the inspection data does not indicate potential damage to the route 102, then additional inspection data may not need to be acquired by the trailing sensor 108B. As a result, flow of the method 700 may return to 702, where additional inspection data of the route 102 is obtained. If the inspection data does indicate potential damage to the route 102, however, then additional inspection data may be acquired by the trailing sensor 108B. As a result, flow of the method 700 may continue to 706.

At 706, the section of interest 300 (shown in FIG. 3) of the route 102 is identified. As described above, the section of interest 300 is identified to include the portion of the route 102 that includes the potential damage. The section of interest 300 may be identified by determining the location of the leading sensor 108A when the inspection data that is indicative of the potential damage was acquired.

At 708, the time at which the trailing sensor 108B is to acquire additional inspection data of the section of interest 300 in the route 102 is determined. This time may be determined based on the separation distance 400 (shown in FIG. 4) and the velocity of the vehicle system 100. Additionally or alternatively, this time may be determined based on the separation distance 400 and a designated upcoming change in the velocity of the vehicle system 100, such as when the controller 202 (shown in FIG. 2) directs the vehicle system 100 to slow down for the trailing sensor 108B, as described above.

At 710, a determination is made as to whether measurement conditions of the vehicle system 100 are to be changed for the trailing sensor 108B. For example, a decision may be made as to whether the vehicle system 100 should slow down to increase the resolution and/or amount of the additional inspection data acquired by the trailing sensor 108B. This decision may additionally or alternatively include a determination of whether to reduce slack in the coupler devices 110 of the vehicle system 100 to stretch the vehicle system 100 and reduce false readings by the trailing sensor 108B. For example, reducing slack and stretching the vehicle system 100 may eliminate false readings that may occur with the trailing sensor 108B when the trailing vehicle 104B suddenly jerks or accelerates relative to the other vehicles 104, 106.

If the measurement conditions of the vehicle system 100 are to be changed, then the movement of the vehicle system 100 may need to be modified. As a result, flow of the method 700 may proceed to 712. Otherwise, flow of the method 700 may continue to 714.

At 712, movement of the vehicle system 100 is modified, such as by slowing down speed of the vehicle system 100 and/or changing slack of the vehicle system 100. As described above, reducing the velocity of the vehicle system 100 may allow more time for the trailing sensor 108B to acquire the additional inspection data. Reducing the slack of the vehicle system 100 (e.g., between the trailing vehicle 104B and/or one or more other vehicles 104, 106) may reduce false readings made by the trailing sensor 108B. For example, reducing the slack can stretch the vehicle system 100 so that the trailing vehicle 104B and the trailing sensor 108B are not suddenly moved relative to the route 102.

At 714, the trailing sensor 108B is directed to acquire additional inspection data in the section of interest 300 of the route 102. The trailing sensor 108B may be directed to acquire the data at a time when the trailing sensor 108B passes over the section of interest 300. In one embodiment, the trailing sensor 108B may only be activated to acquire the additional inspection data when the section of interest 300 is identified based on the inspection data acquired by the leading sensor 108A.

The inspection data acquired by the leading sensor 108A and/or the trailing sensor 108B may be used to identify and/or characterize damage to the route 102. Acquiring different types of inspection data, acquiring different amounts of inspection data, acquiring the inspection data at different resolutions, and the like, during a single pass of the vehicle system 100 over the potentially damaged portion of the route 102 can be more efficient than using multiple, different, and/or separate systems or vehicle systems to examine the route 102.

In another embodiment, a sensing system is provided that includes a leading sensor, a trailing sensor, and a route examining unit. The leading sensor is configured to be coupled to a vehicle system that travels along a route. The leading sensor also is configured to acquire first inspection data indicative of a condition of the route as the vehicle system travels over the route. The condition may represent the health (e.g., damaged or not damaged, a degree of damage, and the like) of the route. The trailing sensor is configured to be coupled to the vehicle system and to acquire additional, second inspection data that is indicative of the condition to the route subsequent to the leading sensor acquiring the first inspection data. The route examining unit is configured to be disposed onboard the vehicle system and to identify a section of interest in the route based on the first inspection data acquired by the leading sensor. The route examining unit also is configured to direct the trailing sensor to acquire the second inspection data within the section of interest in the route when the first inspection data indicates damage to the route in the section of interest.

In one aspect, the leading sensor is configured to be coupled with and acquire the first inspection data from a leading vehicle in the vehicle system and the trailing sensor is configured to be coupled with and acquire the second inspection data from a trailing vehicle in the vehicle system. The leading vehicle and the trailing vehicle are mechanically directly or indirectly interconnected with each other in the vehicle system such that, in at least one direction of travel of the vehicle system, the leading vehicle travels over the section of interest in the route before the trailing vehicle.

In one aspect, the leading sensor and the trailing sensor may be coupled to the same vehicle in the vehicle system.

In one aspect, the leading sensor is configured to acquire the first inspection data and the trailing sensor is configured to acquire the second inspection data during a single pass of the vehicle system over the section of interest in the route.

In one aspect, the first inspection data acquired by the leading sensor and the additional inspection data acquired by the trailing sensor are different types of inspection data.

In one aspect, the leading sensor is configured to acquire the first inspection data at a lower resolution level and the trailing sensor is configured to acquire the second inspection data at a greater resolution level. The resolution levels may represent how much inspection data is acquired per unit time, an amount of inspection data that is acquired during a pass of the respective sensor over the section of interest in the route, and the like.

In one aspect, the leading sensor is configured to be coupled to a leading locomotive and the trailing sensor is configured to be coupled to a trailing locomotive of the vehicle system.

In one aspect, the trailing sensor is configured to acquire the second inspection data responsive to the route examining unit determining that the first inspection data indicates the damage to the route.

In one aspect, the trailing sensor is configured to acquire the second inspection data only when the route examining unit determines that the first inspection data indicates the damage to the route.

In one aspect, the route examining unit is configured to determine when to direct the trailing sensor to begin acquiring the second inspection data based on a velocity of the vehicle system and a separation distance between the leading sensor and the trailing sensor.

In one aspect, the route examining unit is configured to communicate with a location determination system of the vehicle system to determine a location of the section of interest in the route and to direct the trailing sensor to being acquiring the second inspection data based on a velocity of the vehicle system and the location of the section of interest.

In one aspect, the route examining unit is configured to direct a controller of the vehicle system to at least one of autonomously control the vehicle system or direct an operator of the vehicle system to slow the vehicle system down upon determination that the first inspection data indicates damage to the route. The controller may be an onboard processing device that controls operations of the vehicle system or at least one of the vehicles.

In one aspect, the route examining unit is configured to direct a controller of the vehicle system to at least one of autonomously control the vehicle system or direct the operator such that the vehicle system travels faster over the section of interest when the leading sensor passes over the section of interest than when the trailing sensor passes over the section of interest. The controller may be an onboard processing device that controls operations of the vehicle system or at least one of the vehicles.

In one aspect, the route examining unit is configured to direct a controller of the vehicle system to at least one of autonomously control the vehicle system or direct an operator of the vehicle system to reduce slack in one or more coupler devices of the vehicle system between the trailing vehicle and one or more other vehicles in the vehicle system when the first inspection data indicates the damage to the route. The controller may be an onboard processing device that controls operations of the vehicle system or at least one of the vehicles.

In one aspect, the route examining unit is configured to transmit a notification signal to an off-board location responsive to identification of damage to the route based on one or more of the first inspection data and/or the second inspection data, the notification signal notifying the off-board location of at least one of a location of the damage to the route and/or a type of damage to the route.

In one aspect, the route examining unit is configured to transmit a warning signal to one or more other vehicles or vehicle systems responsive to identification of damage to the route based on one or more of the first inspection data and/or the second inspection data, the warning signal notifying the one or more other vehicles or vehicle systems of at least one of a location of the damage to the route and/or a type of damage to the route.

In another embodiment, a method (e.g., for acquiring inspection data of a route) includes acquiring first inspection data indicative of a condition of a route from a leading sensor coupled to a leading vehicle in a vehicle system as the vehicle system travels over the route, determining that the first inspection data indicates damage to the route in a section of interest in the route, and directing a trailing sensor coupled to a trailing vehicle of the vehicle system to acquire additional, second inspection data of the route when the first inspection data indicates the damage to the route. The leading vehicle and the trailing vehicle are mechanically directly or indirectly interconnected with each other in the vehicle system such that the leading vehicle passes over the section of interest of the route before the trailing vehicle.

In one aspect, acquiring the first inspection data and directing the trailing sensor to acquire the second inspection data occurs such that both the first inspection data and the second inspection data are acquired during a single pass of the vehicle system over the section of interest in the route.

In one aspect, the first inspection data acquired by the leading sensor and the second inspection data acquired by the trailing sensor are different types of inspection data.

In one aspect, acquiring the first inspection data is acquired at a first resolution level and the second inspection data is acquired at a second resolution level that is greater than the first resolution level. The resolution levels may represent how much inspection data is acquired per unit time, an amount of inspection data that is acquired during a pass of the respective sensor over the section of interest in the route, and the like.

In one aspect, directing the trailing sensor to acquire the second inspection data includes directing the trailing sensor when to acquire the second inspection data based on a velocity of the vehicle system and a separation distance between the leading sensor and the trailing sensor.

In one aspect, the method also includes slowing movement of the vehicle system responsive to determining that the first inspection data indicates the damage to the route.

In one aspect, the method also includes reducing slack in one or more coupler devices between the trailing vehicle and one or more other vehicles in the vehicle system responsive to determining that the first inspection data indicates the damage to the route.

In another embodiment, a sensing system includes a leading sensor, a trailing sensor, and a route examining unit. The leading sensor is configured to be coupled to a leading rail vehicle of a rail vehicle system that travels along a track. The leading sensor also is configured to acquire first inspection data indicative of a condition of the track in an examined section of the track as the rail vehicle system travels over the track. The trailing sensor is configured to be coupled to a trailing rail vehicle of the rail vehicle system and to acquire additional, second inspection data indicative of the condition to the track subsequent to the leading rail vehicle passing over the examined section of the track and the leading sensor acquiring the first inspection data. The route examining unit is configured to be disposed onboard the rail vehicle system. The route examining unit also is configured to direct the trailing sensor to acquire the second inspection data in the examined section of the track when the first inspection data indicates damage to the track such that both the leading sensor and the trailing sensor acquire the first inspection data and the second inspection data, respectively, of the examined section of the track during a single pass of the rail vehicle system over the examined section of the track.

In one aspect, the leading rail vehicle and the trailing rail vehicle are locomotives mechanically interconnected with each other by one or more railcars in the vehicle system.

In one aspect, the first inspection data acquired by the leading sensor and the second inspection data acquired by the trailing sensor are different types of inspection data.

In one aspect, the leading sensor is configured to acquire the first inspection data at a first resolution level and the trailing sensor is configured to acquire the second inspection data at a second resolution level that is greater than the first resolution level.

In one aspect, at least one of the route examining unit or the trailing sensor is configured to select the second resolution level, from among a plurality of available sensor resolution levels, based on at least one of a current speed of the vehicle system, a category of the damage, or a degree of the damage.

In one aspect, the trailing sensor is configured to acquire the second inspection data responsive to the route examining unit determining that the first inspection data indicates the damage to the track.

In one aspect, the route examining unit is configured to direct a controller of the vehicle system to at least one of autonomously control the rail vehicle system or direct an operator of the rail vehicle system to slow movement of the rail vehicle system down upon determination that the first inspection data indicates damage to the track. The controller may be an onboard processing device that controls operations of the vehicle system or at least one of the vehicles.

In one aspect, the route examining unit is configured to direct a controller of the vehicle system to at least one of autonomously control the rail vehicle system or direct an operator of the rail vehicle system to decrease slack in one or more coupler devices that couple the trailing rail vehicle with one or more other vehicles in the vehicle system when the first inspection data indicates the damage to the track. The controller may be an onboard processing device that controls operations of the vehicle system or at least one of the vehicles.

In one aspect, a sensing system comprises a leading sensor configured to be coupled to a leading rail vehicle of a rail vehicle system that travels along a track. The leading sensor is also configured to automatically acquire first inspection data indicative of a condition of the track in an examined section of the track as the rail vehicle system travels over the track. The first inspection data is acquired at a first resolution level. The sensing system further comprises a trailing sensor configured to be coupled to a trailing rail vehicle of the rail vehicle system and to automatically acquire additional, second inspection data indicative of the condition of the track subsequent to the leading rail vehicle passing over the examined section of the track and the leading sensor acquiring the first inspection data. The second inspection data is acquired at a second resolution level that is greater than the first resolution level. The leading rail vehicle and the trailing rail vehicle are directly or indirectly mechanically connected in the rail vehicle system. The sensing system further includes a route examining unit configured to be disposed onboard the rail vehicle system. The route examining unit is also configured to automatically direct the trailing sensor to acquire the second inspection data in the examined section of the track when the first inspection data indicates damage to the track, such that both the leading sensor and the trailing sensor acquire the first inspection data and the second inspection data, respectively, of the examined section of the track during a single pass of the rail vehicle system over the examined section of the track. In one aspect, the rail vehicle system may be a train, and the leading rail vehicle and the trailing rail vehicle may be first and second locomotives of the train.

In another embodiment, a sensing system includes a route examining unit that is configured to be disposed onboard a vehicle system that travels along a route. The route examining unit also is configured to receive first inspection data from a leading sensor configured to be coupled to a leading vehicle of the vehicle system as the vehicle system travels over the route. The first inspection data is indicative of a condition of the route in an examined section of the route. The route examining unit is further configured to identify damage in the examined section of the route based on the first inspection data and to direct a trailing sensor to acquire second inspection data in the examined section of the route responsive to identifying the damage. The trailing sensor is configured to be coupled to a trailing vehicle of the vehicle system that is indirectly or directly mechanically coupled to the leading vehicle.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

1. A sensing system comprising:
a leading sensor configured to be coupled to a leading vehicle in a vehicle system that travels along a route, the leading sensor also configured to acquire first inspection data indicative of a condition of the route as the vehicle system travels over the route;
a trailing sensor configured to be coupled to a different, trailing vehicle that is directly or indirectly mechanically coupled with the leading vehicle in the vehicle system, the trailing sensor also configured to acquire additional, second inspection data indicative of the condition to the route subsequent to the leading sensor acquiring the first inspection data; and
a route examining unit configured to be disposed onboard the vehicle system and to identify a section of interest in the route based on the first inspection data acquired by the leading sensor, wherein the route examining unit also is configured to direct the trailing sensor to acquire the second inspection data within the section of interest in the route when the first inspection data indicates damage to the route in the section of interest.

2. The sensing system of claim 1, wherein the leading vehicle and the trailing vehicle are mechanically directly or indirectly interconnected with each other in the vehicle system such that, in at least one direction of travel of the vehicle system, the leading vehicle travels over the section of interest in the route before the trailing vehicle.

3. The sensing system of claim 1, wherein the leading sensor is configured to acquire the first inspection data and the trailing sensor is configured to acquire the second inspection data during a single pass of the vehicle system over the section of interest in the route.

4. The sensing system of claim 1, wherein the first inspection data acquired by the leading sensor and the second inspection data acquired by the trailing sensor are different types of inspection data.

5. The sensing system of claim 1, wherein the leading sensor is configured to acquire the first inspection data at a first resolution level and the trailing sensor is configured to acquire the second inspection data at a second resolution level that is greater than the first resolution level such that the trailing sensor acquires a greater amount of data of the section of interest in the route than the leading sensor.

6. The sensing system of claim 1, wherein the leading vehicle is a leading locomotive and the trailing vehicle is a trailing locomotive of the vehicle system.

7. The sensing system of claim 1, wherein the trailing sensor is configured to acquire the second inspection data responsive to the route examining unit determining that the first inspection data indicates the damage to the route.

8. The sensing system of claim 1, wherein the route examining unit is configured to determine when to direct the trailing sensor to begin acquiring the second inspection data based on a velocity of the vehicle system and a separation distance between the leading sensor and the trailing sensor.

9. The sensing system of claim 1, wherein the route examining unit is configured to direct a controller of the vehicle system to at least one of autonomously control the vehicle system or direct an operator of the vehicle system to slow the vehicle system down upon determination that the first inspection data indicates damage to the route and prior to the trailing sensor traveling over the section of interest in the route.

10. The sensing system of claim 1, wherein the route examining unit is configured to direct a controller of the vehicle system to at least one of autonomously control the vehicle system or direct an operator of the vehicle system to reduce slack in one or more coupler devices between the trailing vehicle and one or more other vehicles in the vehicle system when the first inspection data indicates the damage to the route and prior to the trailing sensor traveling over the section of interest in the route.

11. A method comprising:
acquiring first inspection data indicative of a condition of a route from a leading sensor coupled to a leading vehicle in a vehicle system as the vehicle system travels over the route;
determining that the first inspection data indicates damage to the route in a section of interest in the route; and
directing a trailing sensor coupled to a trailing vehicle of the vehicle system to acquire additional, second inspection data of the route when the first inspection data indicates the damage to the route, the leading vehicle and the trailing vehicle mechanically directly or indirectly interconnected with each other in the vehicle system, and the leading vehicle passing over the section of interest of the route before the trailing vehicle.

12. The method of claim 11, wherein acquiring the first inspection data and directing the trailing sensor to acquire the second inspection data occurs such that both the first inspection data and the second inspection data are acquired during a single pass of the vehicle system over the section of interest in the route.

13. The method of claim 11, wherein the first inspection data acquired by the leading sensor and the second inspection data acquired by the trailing sensor are different types of inspection data.

14. The method of claim 11, wherein the first inspection data is acquired at a first resolution level, and the second inspection data is acquired at a second resolution level that is greater than the first resolution level such that the second inspection data is greater amount of data than the first inspection data.

15. The method system of claim 11, further comprising slowing movement of the vehicle system responsive to determining that the first inspection data indicates the damage to the route and prior to the trailing sensor traveling over the section of interest in the route.

16. The method of claim 11, further comprising reducing slack in one or more coupler devices between the trailing vehicle and one or more other vehicles in the vehicle system responsive to determining that the first inspection data indicates the damage to the route and prior to the trailing sensor traveling over the section of interest in the route.

17. A sensing system comprising:
a leading sensor configured to be coupled to a leading rail vehicle of a rail vehicle system that travels along a track, the leading sensor also configured to acquire first inspection data indicative of a condition of the track in an examined section of the track as the rail vehicle system travels over the track;
a trailing sensor configured to be coupled to a trailing rail vehicle of the rail vehicle system and to acquire additional, second inspection data indicative of the condition of the track subsequent to the leading rail vehicle passing over the examined section of the track and the leading sensor acquiring the first inspection data; and
a route examining unit configured to be disposed onboard the rail vehicle system, the route examining unit also configured to direct the trailing sensor to acquire the second inspection data in the examined section of the track when the first inspection data indicates damage to the track such that both the leading sensor and the trailing sensor acquire the first inspection data and the second inspection data, respectively, of the examined section of the track during a single pass of the rail vehicle system over the examined section of the track.

18. The sensing system of claim 17, wherein the leading rail vehicle and the trailing rail vehicle are locomotives mechanically interconnected with each other by one or more rail cars in the vehicle system.

19. The sensing system of claim 17, wherein the first inspection data acquired by the leading sensor and the second inspection data acquired by the trailing sensor are different types of inspection data.

20. The sensing system of claim 17, wherein the leading sensor is configured to acquire the first inspection data at a first resolution level and the trailing sensor is configured to acquire the second inspection data at a second resolution level that is greater than the first resolution level such that the second inspection data includes a greater amount of data than the first inspection data.

21. The sensing system of claim 20, wherein at least one of the route examining unit or the trailing sensor is configured to select the second resolution level, from among a plurality of available sensor resolution levels, based on at least one of a current speed of the vehicle system, a category of the damage, or a degree of the damage.

22. The sensing system of claim 17, wherein the trailing sensor is configured to acquire the second inspection data responsive to the route examining unit determining that the first inspection data indicates the damage to the track.

23. The sensing system of claim 17, wherein the route examining unit is configured to direct a controller of the vehicle system to at least one of autonomously control the rail vehicle system or direct an operator of the rail vehicle system to slow movement of the rail vehicle system down upon determination that the first inspection data indicates damage to the track and prior to the trailing sensor traveling over the damage to the track.

24. The sensing system of claim 17, wherein the route examining unit is configured to direct a controller of the vehicle system to at least one of autonomously control the rail vehicle system or direct an operator of the rail vehicle system to decrease slack in one or more coupler devices that couple the trailing rail vehicle with one or more other vehicles in the vehicle system when the first inspection data indicates the damage to the track and prior to the trailing sensor traveling over the damage to the track.

25. A sensing system comprising:
a leading sensor configured to be coupled to a leading rail vehicle of a rail vehicle system that travels along a track, the leading sensor also configured to automatically acquire first inspection data indicative of a condition of the track in an examined section of the track as the rail vehicle system travels over the track, wherein the first inspection data is acquired at a first resolution level;
a trailing sensor configured to be coupled to a trailing rail vehicle of the rail vehicle system and to automatically acquire additional, second inspection data indicative of the condition of the track subsequent to the leading rail vehicle passing over the examined section of the track and the leading sensor acquiring the first inspection data, wherein the second inspection data is acquired at a second resolution level that is greater than the first resolution level such that the second inspection data includes a greater amount of data than the first inspection data, and wherein the leading rail vehicle and the trailing rail vehicle are directly or indirectly mechanically connected in the rail vehicle system; and
a route examining unit configured to be disposed onboard the rail vehicle system, the route examining unit also configured to automatically direct the trailing sensor to acquire the second inspection data in the examined section of the track when the first inspection data indicates damage to the track such that both the leading sensor and the trailing sensor acquire the first inspection data and the second inspection data, respectively, of the examined section of the track during a single pass of the rail vehicle system over the examined section of the track.

26. A sensing system comprising:
a route examining unit configured to be disposed onboard a vehicle system that travels along a route, wherein the route examining unit is configured to receive first inspection data from a leading sensor configured to be coupled to a leading vehicle of the vehicle system as the vehicle system travels over the route, the first inspection data indicative of a condition of the route in an examined section of the route;
wherein the route examining unit is further configured to identify damage in the examined section of the route based on the first inspection data; and
wherein the route examining unit is further configured to direct a trailing sensor to acquire second inspection data in the examined section of the route responsive to identifying the damage, the trailing sensor configured to be coupled to a trailing vehicle of the vehicle system that is indirectly or directly mechanically coupled to the leading vehicle.
